(19) United States
(12) Patent Application Publication
(10) Pub. No.: US 2020/0070367 A1
(43) Pub. Date: Mar. 5, 2020

(54) LOAD BALANCING DEVICE FOR ROBOT ARM

(71) Applicant: INDUSTRIAL TECHNOLOGY RESEARCH INSTITUTE, Chutung (TW)

(72) Inventors: Chia-Chung SUNG, Taichung City (TW); Shang-Te CHEN, Taichung City (TW); Cheng-Yu CHU, Chiayi City (TW); Meng-He WU, Taichung City (TW); Jan-Hao CHEN, Hemei Township (TW)

(73) Assignee: INDUSTRIAL TECHNOLOGY RESEARCH INSTITUTE, Chutung (TW)

(21) Appl. No.: 16/193,623

(22) Filed: Nov. 16, 2018

(30) Foreign Application Priority Data
Aug. 28, 2018 (TW) 107129989

(51) Int. Cl. B25J 19/00

(52) U.S. Cl. CPC B25J 19/0012

(57) ABSTRACT

A load balancing device for a robot arm including a pneumatic cylinder and a piston rod is provided. The pneumatic cylinder, used to store a gas, includes a first chamber, a second chamber and a communicating passage, wherein the communicating passage connects the first chamber and the second chamber. The piston rod has one end connected to the robot arm and the other end slidably disposed in the pneumatic cylinder. The piston rod adjusts the volume and the pressure of the gas in the first chamber and the second chamber according to a load, wherein the first chamber and the second chamber are coaxially disposed in the axial direction of the pneumatic cylinder.

This application claims the benefit of Taiwan application Serial No. 107129989, filed Aug. 28, 2018, the subject matter of which is incorporated herein by reference.

### BACKGROUND OF THE INVENTION

### Field of the Invention

The invention relates in general to a load balancing device for a robot arm, and more particularly to a load balancing device having a passive pneumatic cylinder.

### Description of the Related Art

Since the high-load robot arm needs to carry an object of 100 kg above, the robot arm has a heavier structural weight and a longer horizontal extension (about 3M). The load can generate a torque of 10000 Nm above. Currently, the motor and the reducer used in the load balancing device for axial joint can only provide a torque of 5000 Nm, and cannot meet the operation requirement of the high-load robot arm. Therefore, it has become a prominent task for the industries to provide a load balancing device which can meet the operation requirement of the high-load robot arm.

### SUMMARY OF THE INVENTION

The present invention relates to a load balancing device for a robot arm. The load balancing device has a series dual chamber pneumatic cylinder. The piston rod instantly adjusts the volume and the pressure of the gas in the pneumatic cylinder according to a load and generates a torque inverse to that of the load to achieve balance.

According to one embodiment of the present invention, a load balancing device for a robot arm including a pneumatic cylinder and a piston rod is provided. The pneumatic cylinder, used to store a gas, includes a first chamber, a second chamber, and a communicating passage communicating the first chamber and the second chamber. The piston rod has one end connected to the robot arm and the other end slidably disposed in the pneumatic cylinder. The piston rod adjusts the volume and the pressure of the gas in the first chamber and the second chamber according to a load, wherein the first chamber and the second chamber are coaxially disposed in the axial direction of the pneumatic cylinder.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 is a schematic diagram of a load balancing device for a robot arm according to an embodiment of the invention, wherein the robot arm is at an initial position.

FIG. 2 is a schematic diagram of the interior of the load balancing device of FIG. 1.

FIG. 3 is a schematic diagram of a load balancing device for a robot arm according to an embodiment of the invention, wherein the robot arm is at a horizontal extension position.

FIG. 4 is a schematic diagram of the interior of the load balancing device of FIG. 3.

FIG. 5 and FIG. 6 are schematic diagrams of another two types of load balancing devices.

### DETAILED DESCRIPTION OF THE INVENTION

Detailed descriptions of the invention are disclosed below with a number of embodiments. However, the disclosed embodiments are for explanatory and exemplary purposes only, not for limiting the scope of protection of the invention. Similar/identical designations are used to indicate similar/identical elements.

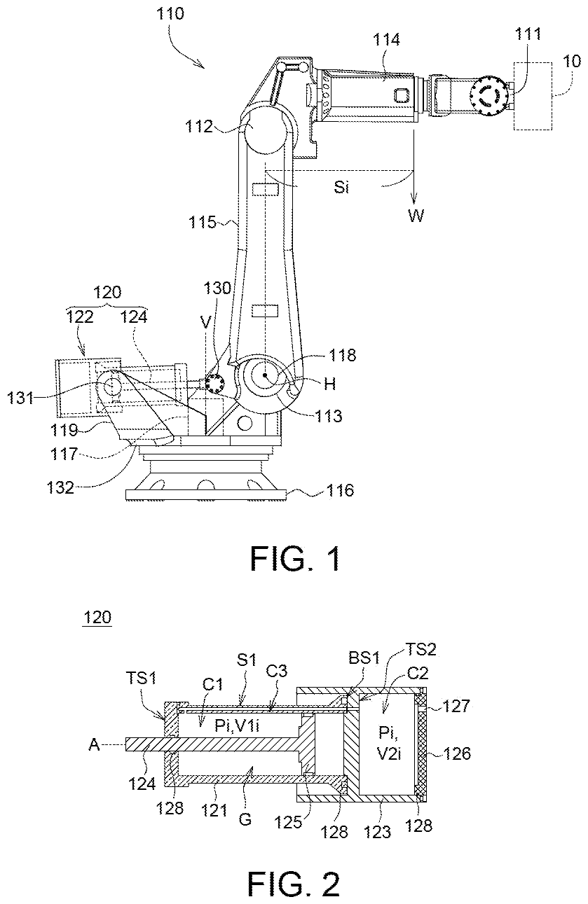

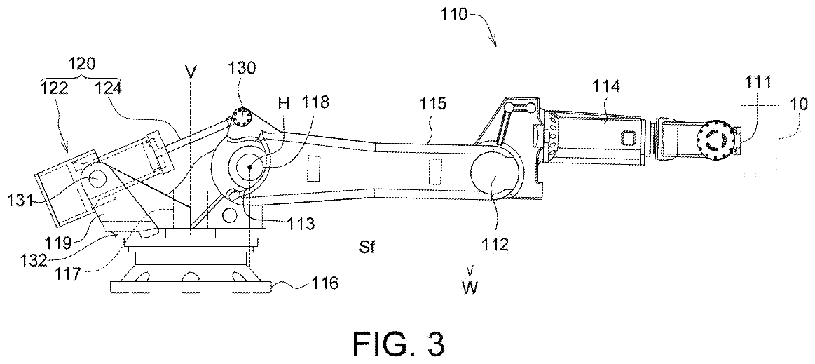

FIG. 1 and FIG. 3 are schematic diagrams of a load balancing device for a robot arm when the robot arm 110 is at an initial position and a horizontal extension position respectively. Refer to FIG. 1. The robot arm 110 has an operation end 111, a first axial joint 112 and a second axial joint 113. The operation end 111 can carry an object 10. The first axial joint 112 is such as an elbow joint; the second axial joint 113 is such as a shoulder joint. The resultant force formed by the structural weight of the robot arm 110 and the gravity of the object 10 is designated by a load W on a gravity axis. When the robot arm 110 is located at an initial position in a vertical state, the distance (force arm) Si between the load W on the gravity axis and the second axial joint 113 is shorter, and the generated torque W*Si is relatively smaller. Refer to FIG. 3. When the robot arm 110 moves to a horizontal extension position in a horizontal state from the initial position in the vertical state, the distance (force arm) Sf between the load W on the gravity axis and the second axial joint 113 is longer, and the generated torque W*Sf is relatively larger. Based on the above disclosure, the present embodiment provides a load balancing device 120 for the robot arm 110, which instantly adjusts the volume and the pressure of the gas G in the pneumatic cylinder 122 according to the torque generated by the load W and generates a torque inverse to that of the load W to achieve balance.

Refer to FIG. 1 and FIG. 2. The load balancing device 120 includes a pneumatic cylinder 122 and a piston rod 124. The pneumatic cylinder 122 is used to store a gas G. The pneumatic cylinder 122 includes a first chamber C1, a second chamber C2, and a communicating passage C3 communicating the first chamber C1 and the second chamber C2. The piston rod 124 has one end connected to the robot arm 110 (adjacent to the second axial joint 113) and the other end slidably disposed in the pneumatic cylinder 122. The piston rod 124 adjusts the volume and the pressure of the gas G in the first chamber C1, the communicating passage C3 and the second chamber C2 according to a load W.

Specifically, the robot arm 110 has a first support arm 114, a second support arm 115, a base 116, a first drive device 117 and a second drive device 118. The first support arm 114 rotates with respect to the second support arm 115 via the first axial joint 112. The second support arm 115 rotates with respect to the base 116 via the second axial joint 113. The pneumatic cylinder 122 has one end pivotally connected to a bracket 119 via a rotation shaft 131. The bracket 191 is fixed on the rotation base 132 disposed on the base 116. The rotation base 132 horizontally rotates with respect to the base 116, and the second support arm 115 rotates with respect to the second axial joint 113, such that the load balancing device 120 can rotate and tilt. The first drive device 117 (such as a motor) is disposed on the vertical axis V and used to drive the second axial joint 113 to rotate with respect to the base 116 on the vertical axis V. The second drive device 118 (such as a motor) is disposed on a horizontal axis H and used to drive the second axial joint 113 to rotate with respect to the base 116 on the horizontal axis H.

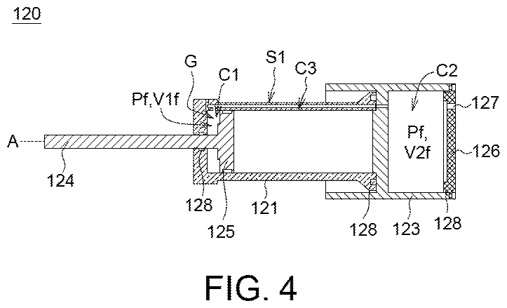

Besides, the piston rod 124 has one end fixed on the second support arm 115 via a bearing 130. The piston rod 124 can move reciprocally on the axial direction of the pneumatic cylinder 122 along with the rotation of the second support arm 115 to adjust the volume and the pressure of the gas G in the pneumatic cylinder 122. As indicated in FIG. 2, when the robot arm 110 is at the initial position, the gas G in the pneumatic cylinder 122 has an initial pressure Pi and an initial volume Vi, wherein the sum of the initial volume V1i of the first chamber C1, the volume of the communicating passage C3 (very small and can be neglected) and the volume V2i of the second chamber C2 is equivalent to the initial volume Vi of the gas G: V1i+V2i=Vi. As indicated in FIG. 4, when the robot arm 110 is at a horizontal extension position, the gas G in the pneumatic cylinder 122, being squeezed by the piston rod 124, will change its volume and pressure, such that the gas G in the pneumatic cylinder 122 will have a limit pressure Pf and a limit volume Vf, wherein the sum of the limit volume V1f of the first chamber C1, the volume of the communicating passage C3 (very small and can be neglected) and the volume V2f of the second chamber C2 is equivalent to the limit volume Vf of the gas G: V1f+V2f=Vf.

According to the ideal gas formula, at a fixed temperature, the volume of a fixed amount of the gas G is inversely proportional to the pressure. Therefore, the product of the volume and the pressure of the gas G, either before or after being squeezed by the piston rod 124, is a constant value: Pi*Vi=Pf*Vf, wherein Vi>Vf, Pi<Pf. It can be known that when the robot arm 110 moves to the horizontal extension position from the initial position, the torque of the load W increases to W*Sf from W*Si, and the pressure of the gas G in the pneumatic cylinder 122 concurrently increases to Pf from Pi to provide an inverse torque to compensate the insufficient torque of the second drive device 118 (such as a motor).

In an embodiment, the initial pressure Pi of the gas G in the pneumatic cylinder 122 is 7 bar (kg/cm²), and the initial volume Vi is between 23000 cm³ and 24000 cm³. The limit pressure Pf of the gas G in the pneumatic cylinder 122 is 12 bar (kg/cm²), and the limit volume Vf is between 13000 cm³ and 14000 cm³. When the robot arm 110 moves to the horizontal extension position from the initial position, the torque of the load W increases to 11117 Nm from 1080 Nm. Meanwhile, the compensation torque provided by the pneumatic cylinder 122 increases to 8584 Nm from 338 Nm. Therefore, with a torque of 742 Nm to 2533 Nm provided by the second drive device 118 (such as a motor and a reducer), the load balancing device 120 will provide an inverse torque to achieve balance, and the requirement for the operation of the robot arm 110 with a high load W will be satisfied.

In an embodiment, the pneumatic cylinder 122 is integrally with the first chamber C1 and the second chamber C2, which are coaxially disposed on the axial direction A of the pneumatic cylinder 122, hence simplifying the internal parts and avoiding the risk of poor assembly. Also, since the first chamber C1 and the second chamber C2 are disposed coaxially, the volume of the pneumatic cylinder 122 can be minimized and the manufacturing cost of the pneumatic cylinder 122 can be reduced.

Refer to FIG. 2 and FIG. 4. The pneumatic cylinder 122 includes a first hollow body 121, a second hollow body 123, a fixing base 126 and a plurality of sealing elements 128. The sealing elements 128 are tightly sealed at the junction between every adjacent two of the first hollow body 121, the second hollow body 123, the fixing base 126 and the piston rod 124 to avoid the leakage of the gas G and make the gas G sealed in the first chamber C1 and the second chamber C2.

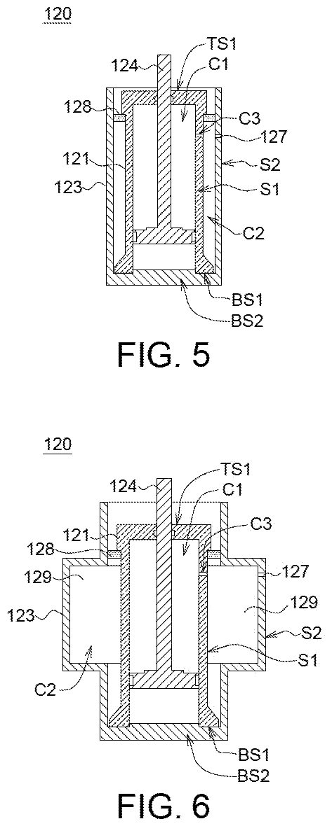

Refer to FIG. 5 and FIG. 6, schematic diagrams of another two types of the load balancing device 120 are shown. As indicated in FIGS. 2, 5 and 6, the first hollow body 121 and the second hollow body 123 are disposed coaxially, and the second hollow body 123 at least partly encloses the first hollow body 121. In FIG. 2, the second hollow body 123 encloses the bottom side BS1 of the first hollow body 121; the top side TS2 of the second hollow body 123 and the bottom side BS of the first hollow body 121 are tightly sealed with each other; the communicating passage C3 passes through the bottom side BS1 of the first hollow body 121 and the top side TS2 of the second hollow body 123 along the axial direction of the side wall S1 to communicate with the second chamber C2 of the second hollow body 123. In FIG. 5 and FIG. 6, the second hollow body 123 completely encloses the bottom side BS1 and the side wall S1 of the first hollow body 121; the bottom side BS1 of the first hollow body 121 and the bottom side BS2 of the second hollow body 123 are tightly sealed with each other; a second chamber C2 is formed between the side wall S1 of the first hollow body 121 and the side wall S2 of the second hollow body 123; the communicating passage C3 passes through the side wall S1 of the first hollow body 121 to communicate with the second chamber C2 of the second hollow body 123. In FIG. 5 and FIG. 6, the second chamber C2 interposed between the first hollow body 121 and the second hollow body 123 can further have a sealing element 128 disposed at the part close to the top side TS1 to seal the gas in the second chamber C2. In FIG. 6, the second hollow body 123 further includes a central protruded portion 129 whose radial size increases, such that the volume of the second chamber C2 can be increased.

In above embodiments, the first chamber C1 is located in the first hollow body 121; a sealed chamber is formed between the top side TS1 of the first hollow body 121 and the piston head 125 at the top of the piston rod 124; the volume of the first chamber C1 can be adjusted along with the movement of the piston rod 124 to change the volume of the gas G in the pneumatic cylinder 122. Besides, the second chamber C2 is located in the second hollow body 123 and has a fixed volume, that is, the volume V2i of the second chamber C2 is equivalent to the volume V2f.

In above embodiments, the fixing base 126 has an air injection hole 127 via which the gas G enters the first hollow body 121 and the second hollow body 123. Therefore, the initial pressure of the gas G in the pneumatic cylinder 122 can be adjusted via the air injection hole 127. The air injection hole 127 is closed in an ordinary state, and is opened during the adjustment of the pressure of the gas G. In FIG. 6 and FIG. 7, the air injection hole 127 is located on the side wall S2 of the second hollow body 123 or the side wall S2 of the central protruded portion 129.

In above embodiments, when the torque generated by the load W increases, the volume of the first chamber C1 decreases along with the movement of the piston rod 124, such that the volume of the gas G relatively decreases, and the pressure of the gas G relatively increases. On the contrary, when the torque generated by the load W decreases, the volume of the first chamber C1 increases along with the movement of the piston rod 124, such that the volume of the gas G relatively increases, and the pressure of the gas G relatively decreases. Therefore, the load balancing device 120 disclosed in above embodiments of the invention can instantly adjust the volume and the pressure of the gas G in the pneumatic cylinder 122 according to the torque generated by the load W and generates a torque inverse to that of the load W to achieve balance.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A load balancing device for a robot arm, comprising:
a pneumatic cylinder used to store a gas, wherein the pneumatic cylinder further comprising a first chamber, a second chamber, and a communicating passage communicating the first chamber and the second chamber; and
a piston rod having one end connected to the robot arm and the other end slidably disposed in the pneumatic cylinder, wherein the piston rod adjusts the volume and the pressure of the gas in the first chamber and the second chamber according to a load, and the first chamber and the second chamber are coaxially disposed in the axial direction of the pneumatic cylinder.

2. The load balancing device according to claim 1, wherein the pneumatic cylinder comprises a first hollow body, a second hollow body, a fixing base, and a plurality of sealing elements sealed in the junction of every adjacent two of the first hollow body, the second hollow body, the fixing base and the piston rod.

3. The load balancing device according to claim 2, wherein the piston rod is located in the first hollow body, and the communicating passage passes through the first hollow body to connect the first hollow body and the second hollow body.

4. The load balancing device according to claim 2, wherein the first hollow body and the second hollow body are disposed coaxially.

5. The load balancing device according to claim 2, wherein the second hollow body at least partly encloses the first hollow body.

6. The load balancing device according to claim 2, wherein the first chamber is located in the first hollow body, and a volume of the first chamber is adjusted along with the movement of the piston rod.

7. The load balancing device according to claim 2, wherein the second chamber is located in the second hollow body and has a fixed volume.

8. The load balancing device according to claim 2, wherein when the torque generated by the load increases, a volume of the first chamber decreases along with the movement of the piston rod, such that the volume of the gas relatively decreases, and the pressure of the gas relatively increases.

9. The load balancing device according to claim 2, wherein when the torque generated by the load decreases, a volume of the first chamber increases along with the movement of the piston rod, such that the volume of the gas relatively increases, and the pressure of the gas relatively decreases.

10. The load balancing device according to claim 2, wherein the fixing base has an air injection hole via which the gas enters the first hollow body and the second hollow body.

11. The load balancing device according to claim 1, wherein the robot arm has an axial joint and a support arm connecting the axial joint, the piston rod has one end fixed on the support arm and adjacent to the axial joint.

12. The load balancing device according to claim 1, wherein the robot arm has a rotation base, the pneumatic cylinder has one end pivotally connected to a bracket, and the bracket is fixed on the rotation base.

13. The load balancing device according to claim 12, wherein the one end of the pneumatic cylinder is pivotally connected to the bracket via a rotation shaft.

14. The load balancing device according to claim 2, wherein a top side of the second hollow body and a bottom side of the first hollow body are tightly sealed with each other.

15. The load balancing device according to claim 14, wherein the communicating passage passes through the top side of the second hollow body and the bottom side of the first hollow body.

16. The load balancing device according to claim 2, wherein the second hollow body completely encloses the first hollow body.

17. The load balancing device according to claim 16, wherein a bottom side of the first hollow body and a bottom side of the second hollow body are tightly sealed with each other.

18. The load balancing device according to claim 16, wherein the second chamber is formed between a side wall of the first hollow body and a side wall of the second hollow body.

19. The load balancing device according to claim 16, wherein the second hollow body further comprises a central protruded portion.

20. The load balancing device according to claim 16, further comprising an air injection hole disposed on a side wall of the second hollow body.
